(19) United States
(12) Patent Application Publication
(10) Pub. No.: US 2015/0205518 A1
(43) Pub. Date: Jul. 23, 2015

(54) CONTEXTUAL DATA FOR NOTE TAKING APPLICATIONS

(71) Applicant: Lenovo (Singapore) Pte. Ltd., Singapore (SG)

(72) Inventors: Bradley Park Strazisar, Cary, NC (US); Steven Richard Perrin, Raleigh, NC (US); Song Wang, Cary, NC (US); Scott Edwards Kelso, Cary, NC (US)

(73) Assignee: Lenovo (Singapore) Pte. Ltd., Singapore (SG)

(21) Appl. No.: 14/161,048

(22) Filed: Jan. 22, 2014

(51) Int. Cl. G06F 3/0488; G06F 17/21; G06K 9/72

(52) U.S. Cl. CPC G06F 3/04883; G06K 9/72; G06F 17/21

(57) ABSTRACT

An aspect provides a method, including: accepting, at a writing input surface of an information handling device, user handwriting inputs to a note taking application; determining, using a processor, contextual information related to the user handwriting inputs to the note taking application; creating, using a processor, an association between at least one content portion of the user hand writing inputs and at least a portion of the contextual information; and storing, in a memory accessible to the information handling device, the association. Other aspects are described and claimed.

### BACKGROUND

Information handling devices (“devices”) come in a variety of forms, for example laptop computing devices, tablet computing devices, smart phones, and the like. Users often take notes with such devices, e.g., during a meeting or a lecture. Device users are increasingly relying on pens to write down important notes, e.g., in a note taking application. Many users prefer to utilize a pen and writing input to create notes in an application (whether it is a dedicated note application or another note taking application, e.g., word processing application) because it is sometimes more convenient than typing, especially when the device form factor lacks a physical keyboard.

### BRIEF SUMMARY

In summary, one aspect provides a method, comprising: accepting, at a writing input surface of an information handling device, user handwriting inputs to a note taking application; determining, using a processor, contextual information related to the user handwriting inputs to the note taking application; creating, using a processor, an association between at least one content portion of the user hand writing inputs and at least a portion of the contextual information; and storing, in a memory accessible to the information handling device, the association.

Another aspect provides an information handling device, comprising: a writing input surface; a processor operatively coupled to the writing input surface; a memory device that stores instructions accessible to the processor, the instructions being executable by the processor to: accept, at the writing input surface, user handwriting inputs to a note taking application; determine contextual information related to the user handwriting inputs to the note taking application; create an association between at least one content portion of the user hand writing inputs and at least a portion of the contextual information; and store the association.

A further aspect provides a product, comprising: a storage device having code stored therewith, the code being executable by a processor and comprising: code that accepts, at a writing input surface of an information handling device, user handwriting inputs to a note taking application; code that determines contextual information related to the user handwriting inputs to the note taking application; code that creates an association between at least one content portion of the user hand writing inputs and at least a portion of the contextual information; and code that stores the association.

The foregoing is a summary and thus may contain simplifications, generalizations, and omissions of detail; consequently, those skilled in the art will appreciate that the summary is illustrative only and is not intended to be in any way limiting.

For a better understanding of the embodiments, together with other and further features and advantages thereof, reference is made to the following description, taken in conjunction with the accompanying drawings. The scope of the invention will be pointed out in the appended claims.

### BRIEF DESCRIPTION OF THE SEVERAL VIEWS OF THE DRAWINGS

FIG. 1 illustrates an example of information handling device circuitry.

FIG. 2 illustrates another example of information handling device circuitry.

FIG. 3 illustrates an example of providing contextual data for note taking applications.

FIG. 4 illustrates an example of utilizing contextual data for searching note taking application data.

### DETAILED DESCRIPTION

It will be readily understood that the components of the embodiments, as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments, as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, the appearance of the phrases “in one embodiment” or “in an embodiment” or the like in various places throughout this specification are not necessarily all referring to the same embodiment.

Furthermore, the described features, structures, or characteristics may be combined in any suitable manner in one or more embodiments. In the following description, numerous specific details are provided to give a thorough understanding of embodiments. One skilled in the relevant art will recognize, however, that the various embodiments can be practiced without one or more of the specific details, or with other methods, components, materials, et cetera. In other instances, well known structures, materials, or operations are not shown or described in detail to avoid obfuscation.

When taking notes during a meeting, class, conference, etc., the quality of the note content is largely up to the user. To capture more meaningful information, users sometimes record audio or video while taking notes. Because the note application data and the additional media data (e.g., audio or video file) are separate, it is left up to the user to organize what portion of the note corresponds to what portion of (e.g., in time) the media. Understandably this proves to be quite challenging, even if only a small amount of notes or audio/video have been stored.

Current attempted solutions capture and index additional information (e.g., audio, video, etc.) by way of a specialized device, e.g., a camera-based smart pen, which synchronizes media, e.g., audio data, to note data files, e.g., created on a paper tablet. However, even through use of such a specialized device, certain issues remain. For example, the audio that is captured does not identify who is speaking or when the words were spoken, e.g., in correlation with when the handwritten note input portions were written.

Accordingly, an embodiment utilizes contextual information to assist a user in organizing his or her notes. An embodiment may leverage several sources of contextual information and index the same in relation to notes (or portions thereof). This provides a rich data set that will assist in linking the note data to other, perhaps more relevant, contextual information. Using such a process, a user may quickly retrieve particular notes (or portions thereof) based on searching using the contextual data, e.g., who was speaking when the note was taken, what was said, which other users were seated near the note taker, etc.

For example, an embodiment captures the context of audio (e.g., keywords thereof), a user's calendar entries (e.g., event name, description, people present and location), as well as the current time and date while a user writes notes. This contextual information is indexed and synchronized, e.g., with the cadence of the user's handwriting to create a timeline based on the amount of notes a user takes. Any of these contextual information streams then may be searched and replayed at a later time.

The nature and use of the contextual information is diverse. For example, speaker recognition may also be leveraged to identify others in the room, e.g., to illustrate who is talking and when and thus correlate this with the note data. Additionally, real time (or substantially real time) information regarding which person is speaking at any point in time may be illustrated graphically, e.g., in the margins of the tablet running the note taking application.

The illustrated example embodiments will be best understood by reference to the figures. The following description is intended only by way of example, and simply illustrates certain example embodiments.

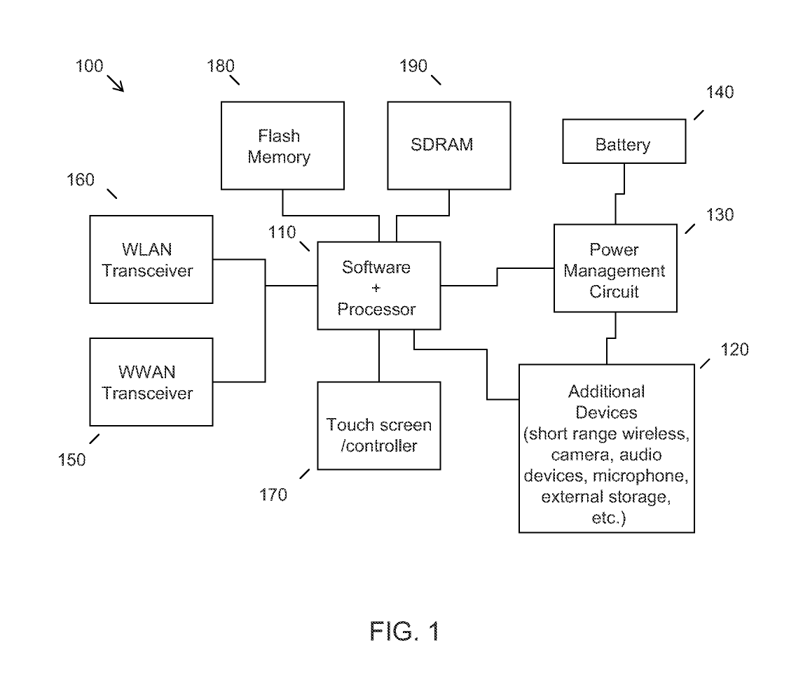

While various other circuits, circuitry or components may be utilized in information handling devices, with regard to smart phone and/or tablet circuitry 100, an example illustrated in FIG. 1 includes a system on a chip design found for example in tablet or other mobile computing platforms. Software and processor(s) are combined in a single chip 110. Processors comprise internal arithmetic units, registers, cache memory, busses, I/O ports, etc., as is well known in the art. Internal busses and the like depend on different vendors, but essentially all the peripheral devices (120) may attach to a single chip 110. The circuitry 100 combines the processor, memory control, and I/O controller hub all into a single chip 110. Also, systems 100 of this type do not typically use SATA or PCI or LPC. Common interfaces, for example, include SDIO and I2C.

There are power management chip(s) 130, e.g., a battery management unit, BMU, which manage power as supplied, for example, via a rechargeable battery 140, which may be recharged by a connection to a power source (not shown). In at least one design, a single chip, such as 110, is used to supply BIOS like functionality and DRAM memory.

System 100 typically includes one or more of a WWAN transceiver 150 and a WLAN transceiver 160 for connecting to various networks, such as telecommunications networks and wireless Internet devices, e.g., access points. Additional devices 120 are commonly included. System 100 often includes a touch screen 170 for data input and display/rendering, e.g., receiving content and navigation inputs via a pen or stylus, as further described herein. System 100 also typically includes various memory devices, for example flash memory 180 and SDRAM 190.

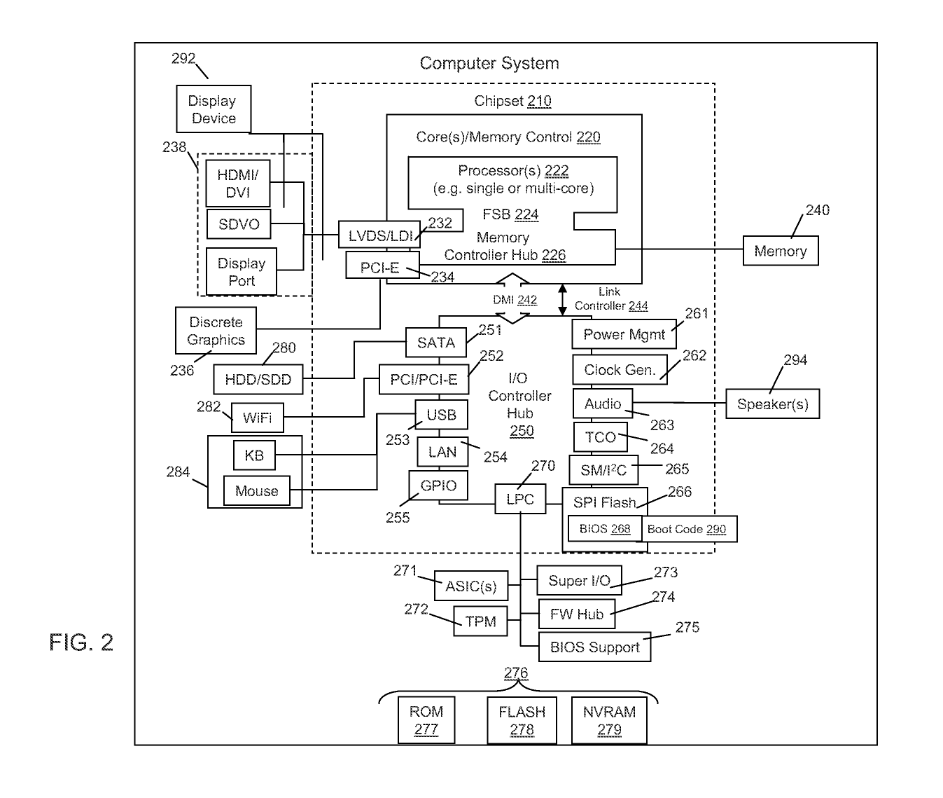

FIG. 2 depicts a block diagram of another example of information handling device circuits, circuitry or components. The example depicted in FIG. 2 may correspond to computing systems such as the THINKPAD series of personal computers sold by Lenovo (US) Inc. of Morrisville, N.C., or other devices. As is apparent from the description herein, embodiments may include other features or only some of the features of the example illustrated in FIG. 2.

The example of FIG. 2 includes a so-called chipset 210 (a group of integrated circuits, or chips, that work together, chipsets) with an architecture that may vary depending on manufacturer (for example, INTEL, AMD, ARM, etc.). INTEL is a registered trademark of Intel Corporation in the United States and other countries. AMD is a registered trademark of Advanced Micro Devices, Inc. in the United States and other countries. ARM is an unregistered trademark of ARM Holdings plc in the United States and other countries. The architecture of the chipset 210 includes a core and memory control group 220 and an I/O controller hub 250 that exchanges information (for example, data, signals, commands, etc.) via a direct management interface (DMI) 242 or a link controller 244. In FIG. 2, the DMI 242 is a chip-to-chip interface (sometimes referred to as being a link between a “northbridge” and a “southbridge”). The core and memory control group 220 include one or more processors 222 (for example, single or multi-core) and a memory controller hub 226 that exchange information via a front side bus (FSB) 224; noting that components of the group 220 may be integrated in a chip that supplants the conventional “northbridge” style architecture. One or more processors 222 comprise internal arithmetic units, registers, cache memory, busses, I/O ports, etc., as is well known in the art.

In FIG. 2, the memory controller hub 226 interfaces with memory 240 (for example, to provide support for a type of RAM that may be referred to as “system memory” or “memory”). The memory controller hub 226 further includes a LVDS interface 232 for a display device 292 (for example, a CRT, a flat panel, touch screen, etc.). A block 238 includes some technologies that may be supported via the LVDS interface 232 (for example, serial digital video, HDMI/DVI, display port). The memory controller hub 226 also includes a PCI-express interface (PCI-E) 234 that may support discrete graphics 236.

In FIG. 2, the I/O hub controller 250 includes a SATA interface 251 (for example, for HDDs, SDDs, etc., 280), a PCI-E interface 252 (for example, for wireless connections 282), a USB interface 253 (for example, for devices 284 such as a digitizer, keyboard, mice, cameras, phones, microphones, storage, other connected devices, etc.), a network interface 254 (for example, LAN), a GPIO interface 255, a LPC interface 270 (for ASICs 271, a TPM 272, a super I/O 273, a firmware hub 274, BIOS support 275 as well as various types of memory 276 such as ROM 277, Flash 278, and NVRAM 279), a power management interface 261, a clock generator interface 262, an audio interface 263 (for example, for speakers 294), a TCO interface 264, a system management bus interface 265, and SPI Flash 266, which can include BIOS 268 and boot code 290. The I/O hub controller 250 may include gigabit Ethernet support.

The system, upon power on, may be configured to execute boot code 290 for the BIOS 268, as stored within the SPI Flash 266, and thereafter processes data under the control of one or more operating systems and application software (for example, stored in system memory 240). An operating system may be stored in any of a variety of locations and accessed, for example, according to instructions of the BIOS 268. As described herein, a device may include fewer or more features than shown in the system of FIG. 2.

Information handling device circuitry, as for example outlined in FIG. 1 or FIG. 2, may be included in user devices that accept pen inputs to a writing surface such as a touch screen. An embodiment may store these user handwriting inputs into a note application data file, e.g., a word processing document. Depending on the note taking application utilized, the user handwriting inputs may be converted to machine text.

An embodiment permits various sources of contextual information to be accessed and associated with the user handwriting inputs, e.g., for later searching. This provides additional, contextually relevant data that may be used to organize and search a user's note taking data files.

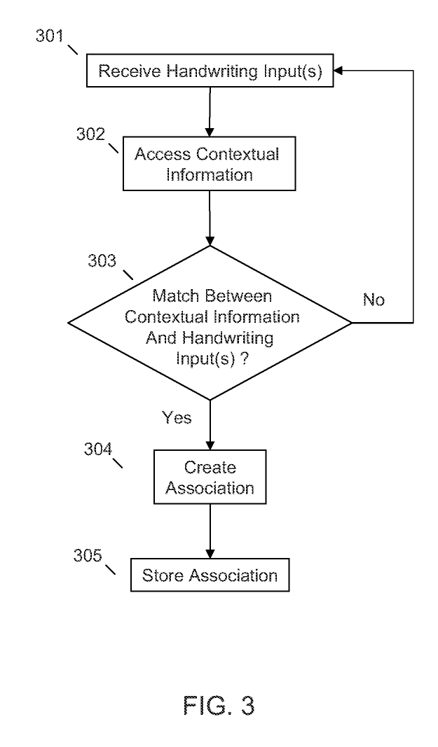

For example, referring to FIG. 3, an embodiment receives user handwriting inputs at 301, e.g., to a pen digitizer, touch screen or like component. An embodiment accesses contextual information at 302. As described herein, the sources of contextual information are essentially unlimited and may only be bounded by the user's device capabilities. Thus, for a device that may capture audio using a microphone, accessing contextual information at 302 may include capturing audio, e.g., of a speaker at a meeting for which the user takes notes. Likewise, device position information, e.g., derived from a GPS system or other location mechanism, may be utilized to provide location context, e.g., location of the meeting.

It should be noted, however, that given a devices may resources, there will very likely be a large amount of contextual information available, even if a particular resource is not available on the user's local device. For example, location information may be derived from a calendar entry of the device's calendar application (e.g., meeting location entry) in the event that the device does not have a GPS system available. Moreover, if a device has connectivity to another device, e.g., using some form of network capability, the other device may be used to supply the contextual information.

Potentially useful types of contextual information will likely include audio data, calendar application data, as well as location data, although these are merely non-limiting examples. Having accessed contextual information at 302, an embodiment may determine if the contextual information matches any of the content of the user handwriting inputs at 303. That is, rather than simply matching the time at which a user creates a note with an entire audio file, an embodiment may determine if the content of the note, e.g., keywords of the user handwriting input, match or are otherwise associated with the contextual information, e.g., keywords thereof.

By way of example, an embodiment may determine at 303 that a user has provided handwriting input regarding “topic A” of a meeting, e.g., by determining that these keywords are included in the handwriting input received at 301. Likewise, an embodiment may determine that a source of contextual information, e.g., a calendar entry for a specific date and time is entitled “Topic A”, for example accessed on the calendar application of the user's device. Thus, at 303, an embodiment may determine that there is a match or an association between the user's notes regarding “Topic A” and the calendar entry with the title “Topic A”.

Additionally, timing information may also be included. For example, an embodiment may determine at 303 that a user has provided handwriting input regarding “Topic A” of a meeting at a particular point in time, e.g., by determining that these keywords are included in the handwriting input received at 301 at a specific time. Likewise, an embodiment may determine that a source of contextual information, e.g., text derived from captured audio data includes the key words “Topic A” at a specific time associated with the user handwriting inputs of interest. This information may thus be utilized to determine there is a match or an association between the user handwriting inputs and the contextual information at 303.

Having determined that there exists an association between the user handwriting inputs and the contextual information at 303, an embodiment may create an association there-between at 304 and store this association at 305 such that it may be utilized, either in the present or at a future time.

For example, an embodiment may allow a user to be notified of currently available contextual information in real-time (or substantially in real-time). By way of example, considering that an embodiment may identify in captured audio data an association between the currently spoken words and the user provided handwriting inputs, an embodiment may further provide the user with in association between the speaker of those words and the handwriting inputs, e.g., via utilizing speaker identification. Thus, an embodiment may present a graphical representation, e.g., picture and/or text based representation, of the speaker associated with the user handwritten inputs, e.g., in the margin of the note taking application.

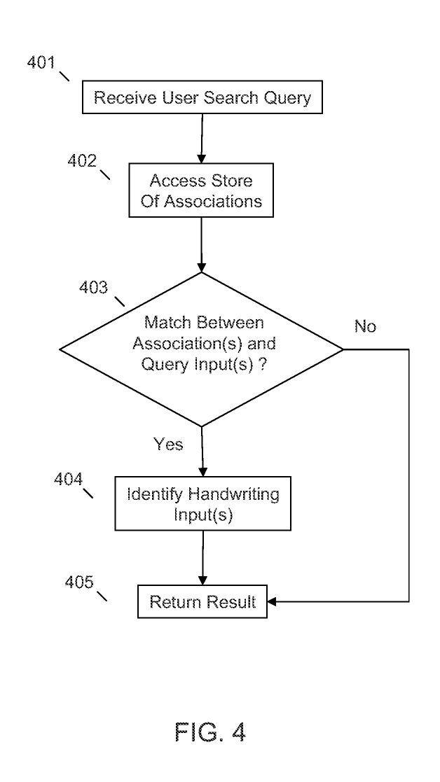

Similarly, an embodiment may allow a user to later leverage the associations, e.g., in searching for notes or finding sub-portions of notes associated with various contextual information. By way of example and referring to FIG. 4, taking the speaker identification contextual information as a representative source, a user may simply recall that some note (or some portion of a note) was taken during a time when a particular person was speaker (or located in the room, etc., depending on the contextual information available). A user, however, may not remember specific key words or file name of the note, or the date and time, etc. Thus, all the user may remember is that a particular speaker was talking when the note was taken.

A user may search, e.g., issue a search query, looking for note(s) that were taken while that particular speaker was speaking Thus, an embodiment may receive a user search query at 401 and access a store of associations, i.e., between contextual information and user handwriting inputs, at 402. An embodiment may utilize the stored associations to determine at 403 if there exists an association linking a user handwriting input, e.g., included in a note file, and contextual information regarding this particular speaker, e.g., derived from speaker identification data.

If there is an association, an embodiment may identify the handwriting inputs (and associated note files/portions thereof) at 404 and return a query result indicating the same at 405. Therefore an embodiment provides for use of the stored associations between contextual information and the user provided handwriting inputs both in real time and at a later time. This permits a user to easily remember what notes were taken, the context in which they were taken, and utilize such information in the future, e.g., when later searching for a previously created note or portion thereof.

As will be appreciated by one skilled in the art, various aspects may be embodied as a system, method or device program product. Accordingly, aspects may take the form of an entirely hardware embodiment or an embodiment including software that may all generally be referred to herein as a “circuit,” “module” or “system.” Furthermore, aspects may take the form of a device program product embodied in one or more device readable medium(s) having device readable program code embodied therewith.

It should be noted that the various functions described herein may be implemented using instructions stored on a device readable storage medium such as a non-signal storage device that are executed by a processor. A storage device may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a storage device is not a signal and “non-transitory” includes all media except signal media.

Program code embodied on a storage medium may be transmitted using any appropriate medium, including but not limited to wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of connection or network, including a local area network (LAN) or a wide area network (WAN), or the connection may be made through other devices (for example, through the Internet using an Internet Service Provider), through wireless connections, e.g., near-field communication, or through a hard wire connection, such as over a USB connection.

Example embodiments are described herein with reference to the figures, which illustrate example methods, devices and program products according to various example embodiments. It will be understood that the actions and functionality may be implemented at least in part by program instructions. These program instructions may be provided to a processor of a general purpose information handling device, a special purpose information handling device, or other programmable data processing device to produce a machine, such that the instructions, which execute via a processor of the device implement the functions/acts specified.

It is worth noting that while specific blocks are used in the figures, and a particular ordering of blocks has been illustrated, these are non-limiting examples. In certain contexts, two or more blocks may be combined, a block may be split into two or more blocks, or certain blocks may be re-ordered or re-organized as appropriate, as the explicit illustrated examples are used only for descriptive purposes and are not to be construed as limiting.

As used herein, the singular “a” and “an” may be construed as including the plural “one or more” unless clearly indicated otherwise.

This disclosure has been presented for purposes of illustration and description but is not intended to be exhaustive or limiting. Many modifications and variations will be apparent to those of ordinary skill in the art. The example embodiments were chosen and described in order to explain principles and practical application, and to enable others of ordinary skill in the art to understand the disclosure for various embodiments with various modifications as are suited to the particular use contemplated.

Thus, although illustrative example embodiments have been described herein with reference to the accompanying figures, it is to be understood that this description is not limiting and that various other changes and modifications may be affected therein by one skilled in the art without departing from the scope or spirit of the disclosure.

What is claimed is:

1. A method, comprising:
accepting, at a writing input surface of an information handling device, user handwriting inputs to a note taking application;
determining, using a processor, contextual information related to the user handwriting inputs to the note taking application;
creating, using a processor, an association between at least one content portion of the user hand writing inputs and at least a portion of the contextual information; and
storing, in a memory accessible to the information handling device, the association.

2. The method of claim 1, wherein the at least one content portion of the user hand writing inputs comprises one or more key words.

3. The method of claim 1, wherein the contextual information is selected from the group consisting of audio data and device calendar data.

4. The method of claim 1, wherein the creating an association between at least one content portion of the user hand writing inputs and at least a portion of the contextual information comprises forming an association between one or more keywords of the user handwriting input and one or more keywords derived from contextual information.

5. The method of claim 1, wherein the creating an association between at least a content portion of the user handwriting inputs and at least a portion of the contextual information comprises forming a plurality of associations between keywords of the user handwriting input and keywords derived from contextual information.

6. The method of claim 5, wherein the plurality of associations are organized as a timeline.

7. The method of claim 1, further comprising:
accepting a user search query;
accessing a store of associations between at least a content portion of the user hand writing inputs and at least a portion of the contextual information;
searching the store of associations using one or more keywords derived from the query;
identifying one or more user handwriting inputs associated with contextual information matching the one or more keywords of the query; and
returning a query result based on said identifying.

8. The method of claim 1, wherein the determining contextual information related to the user handwriting inputs to the note taking application comprises accessing audio data of a speaker associated in time with the user handwriting inputs to the note taking application.

9. The method of claim 8, further comprising:
utilizing the audio data of the speaker associated in time with the user handwriting inputs to the note taking application to identify the speaker; and
providing a representation of the speaker on a display.

10. The method of claim 9, wherein the representation comprises a graphical illustration provided in a note taking application while user input is accepted by the note taking application.

11. An information handling device, comprising:
a writing input surface;
a processor operatively coupled to the writing input surface;
a memory device that stores instructions accessible to the processor, the instructions being executable by the processor to:
accept, at the writing input surface, user handwriting inputs to a note taking application;
determine contextual information related to the user handwriting inputs to the note taking application;
create an association between at least one content portion of the user hand writing inputs and at least a portion of the contextual information; and
store the association.

12. The information handling device of claim 11, wherein the at least one content portion of the user hand writing inputs comprises one or more key words.

13. The information handling device of claim 11, wherein the contextual information is selected from the group consisting of audio data and device calendar data.

14. The information handling device of claim 11, wherein to create an association between at least one content portion of the user hand writing inputs and at least a portion of the contextual information comprises forming an association between one or more keywords of the user handwriting input and one or more keywords derived from contextual information.

15. The information handling device of claim 11, wherein to create an association between at least a content portion of the user handwriting inputs and at least a portion of the contextual information comprises forming a plurality of associations between keywords of the user handwriting input and keywords derived from contextual information.

16. The information handling device of claim 15, wherein the plurality of associations are organized as a timeline.

17. The information handling device of claim 11, wherein the instructions are further executable by the processor to:
accept a user search query;
access a store of associations between at least a content portion of the user hand writing inputs and at least a portion of the contextual information;
search the store of associations using one or more keywords derived from the query;
identify one or more user handwriting inputs associated with contextual information matching the one or more keywords of the query; and
return a query result based on said identifying.

18. The information handling device of claim 11, wherein to determine contextual information related to the user handwriting inputs to the note taking application comprises accessing audio data of a speaker associated in time with the user handwriting inputs to the note taking application.

19. The information handling device of claim 18, wherein the instructions are further executable by the processor to:
utilize the audio data of the speaker associated in time with the user handwriting inputs to the note taking application to identify the speaker; and
provide a representation of the speaker on a display.

20. A product, comprising:
a storage device having code stored therewith, the code being executable by a processor and comprising:
code that accepts, at a writing input surface of an information handling device, user handwriting inputs to a note taking application;
code that determines contextual information related to the user handwriting inputs to the note taking application;
code that creates an association between at least one content portion of the user hand writing inputs and at least a portion of the contextual information; and
code that stores the association.
